(19) United States
(12) Patent Application Publication
(10) Pub. No.: US 2016/0069843 A1
(43) Pub. Date: Mar. 10, 2016

(54) Sample Disk For Ultrasonic Disk Testing Installations

(71) Applicant: Siemens Aktiengesellschaft, Muenchen (DE)

(72) Inventors: Uwe Buechner, Berlin (DE); Werner Heinrich, Oberkraemer OT Baerenklau (DE); Karsten Kolk, Muelheim a.d. Ruhr (DE); Hans-Peter Lohmann, Wesel-Obrighoven (DE); Hubert Mooshofer, Muenchen (DE); Johannes Vrana, Muenchen (DE)

(73) Assignee: Siemens Aktiengesellschaft, Muenchen (DE)

(21) Appl. No.: 14/888,781

(22) PCT Filed: Feb. 18, 2014
(86) PCT No.: PCT/EP2014/053091

§ 371 Date: Nov. 3, 2015

(30) Foreign Application Priority Data
May 23, 2013 (DE) 10 2013 209 615.1

(51) Int. Cl. G01N 29/30

(52) U.S. Cl. CPC G01N 29/30; G01N 2291/0289

(57) ABSTRACT

A sample disc for ultrasonic disc testing equipment includes a cut-out defining a lateral face extending along a radius of the sample disc and along an axis of symmetry of the sample disc. At least one planar sample defect is created through this lateral face of the disc.

### CROSS-REFERENCE TO RELATED APPLICATIONS

This application is a U.S. National Stage Application of International Application No. PCT/EP2014/053091 filed Feb. 18, 2014, which designates the United States of America, and claims priority to DE Application No. 10 2013 209 615.1 filed May 23, 2013, the contents of which are hereby incorporated by reference in their entirety.

### TECHNICAL FIELD

The present invention relates to a sample disk for ultrasonic disk testing installations, to a method for producing such sample disks and to the use thereof.

### BACKGROUND

For qualification and monitoring of ultrasonic disk testing installations, use is made, for example, of wheel disks having artificial defects. Such defects are placed and oriented in such a way that characteristic defect locations and orientations can be tested. Such test disks make it possible to validate both the functionality of an ultrasonic disk testing installation and that of ultrasonic testing methods.

Flat-bottom holes, as they are known, are conventionally incorporated as artificial defects. However, only restricted hole orientations are conventionally possible on account of geometric restrictions. In order to widen the artificial defect spectrum, transverse holes are conventionally used.

### SUMMARY

One embodiment provides a sample disk for ultrasonic disk testing installations, wherein the sample disk is a first right circular cylinder, which extends substantially about an axis of symmetry, with a first base circle surface having a radius and with a second base circle surface parallel to the first; wherein a first part is cut out, which part is bounded by a surface produced by means of a parallel displacement of a straight line, which is parallel to the axis of symmetry, along a closed guidance line which runs in the first base circle surface, by the first base circle surface and by a surface which is parallel or identical to the second base circle surface or runs along the latter; and wherein the guidance line has a straight path section which runs along the radius and a further profile such that a lateral surface is produced on the straight path section on the sample disk, through which lateral surface at least one planar sample defect is created.

In a further embodiment, the at least one planar sample defect is created in a plane defined by means of the radius and the axis of symmetry.

In a further embodiment, a first covering covers the first part over its whole area in a planar and flush manner in the sample disk in the region of the first base circle surface.

In a further embodiment, a second covering covers the first part over its whole area in a planar and flush manner in the sample disk in the region of the second base circle surface.

In a further embodiment, the at least one sample defect is produced as a planar material transition.

In a further embodiment, the planar material transition is produced from ambient air to the sample disk.

In a further embodiment, the planar material transition is produced by means of a flat closed end of a recess which extends tangentially to the radius and which has an open end toward the lateral surface.

In a further embodiment, the straight path section runs with a spacing parallel to the radius and the recess extends perpendicularly to the lateral surface with a depth equal to the spacing.

In a further embodiment, the recess and its flat closed end have been produced by means of flat-bottom drilling from the side of the lateral surface.

In a further embodiment, the at least one sample defect has a round or an angular surface, in particular being circular, rectangular or triangular.

In a further embodiment, the guidance line runs along the straight path section to the circle line of the first base circle surface and along a relatively short circular arc of this circle line to a secant of the first base circle surface and along the secant in the direction of the axis of symmetry.

In a further embodiment, the secant runs parallel to the straight path section and the relatively short circular arc has a minimum length.

In a further embodiment, the guidance line runs along the secant to a circle line of an inner circle, which is arranged in the first base circle surface and is concentric to the axis of symmetry, with a smaller radius than the radius of the first circular cylinder and along a relatively short circular arc of this circle line to the straight path section.

In a further embodiment, a second part is cut out in the sample disk, which part is a second right circular cylinder coaxial to the axis of symmetry, is bounded by the first base circle surface and the second base circle surface, and has, in the first base circle surface, a smaller radius than the radius of the first circular cylinder.

In a further embodiment, the radius of the second circular cylinder is equal to the radius of the inner circle.

Another embodiment provides a method for producing a sample disk as disclosed above, the method including removing the first part from the first circular cylinder of the original sample disk; and producing the at least one planar sample defect as a material transition from a closed planar end of a recess extending tangentially to the radius of the first circular cylinder by means of flat-bottom drilling taking place from the lateral surface and through the latter, to the sample disk.

In a further embodiment, the method includes producing the straight path section with a spacing parallel to the radius of the first circular cylinder and flat-bottom drilling, which takes place perpendicularly to the lateral surface, with a depth equal to the spacing.

In a further embodiment, the method includes removing a second part from the first circular cylinder of the original sample disk before removing the first part.

In a further embodiment, the method includes covering the first part of the sample disk over its whole area in a planar and flush manner in the region of the first base circle surface and/or in the region of the second base circle surface.

Another embodiment provides a method of using a sample disk as disclosed above by positioning the sample disk in an ultrasonic disk testing installation, wherein test heads of a tandem or pitch-catch arrangement are in each case placed oppositely on the first base circle surface and the second base circle surface along the radius of the first base circle surface; and rotating the sample disk in a direction of rotation about the axis of symmetry in such a way that first of all planar sample defects and then the cut-out first part are guided past the test heads.

In a further embodiment, the method includes the use of the sample disk includes evaluating or validating ultrasonic measuring methods or ultrasonic testing installations.

In a further embodiment, the method includes the use of the sample disk includes mechanized and automated evaluation or validation.

In a further embodiment, the method includes the use of the sample disk includes evaluating or validating test disks or test wheel disks measured by means of ultrasound, the sample disk having been adapted to a maximum to the physical extent of said disks.

### BRIEF DESCRIPTION OF THE DRAWINGS

Example embodiments of the invention are described in more detail below with reference to the figures, in which:

FIG. 1 shows a plan view of a first exemplary embodiment of a sample disk according to the invention;

FIG. 2 shows a side view of the first exemplary embodiment of a sample disk according to the invention; and

FIG. 3 shows an exemplary embodiment of a use according to the invention.

### DETAILED DESCRIPTION

Embodiments of the present invention provide a sample disk for ultrasonic disk testing installations in such a way that it is possible to incorporate flat-bottom holes whose flat bottom is oriented axially and radially to an axis of rotation of a disk. With regard to a load state, in particular of wheel disks, precisely such an orientation is important.

Some embodiments provide a sample disk for ultrasonic disk testing installations, wherein the sample disk is a first right circular cylinder, which extends substantially about an axis of symmetry, with a first base circle surface having a radius and with a second base circle surface parallel to the first, wherein a first part is cut out, which part is bounded by a surface produced by means of a parallel displacement of a straight line, which is parallel to the axis of symmetry, along a closed guidance line which runs in the first base circle surface, by the first base circle surface and by a surface which is parallel or identical to the second base circle surface or runs along the latter, and the guidance line has a straight path section which runs along the radius and a further profile such that a lateral surface is produced on the straight path section on the sample disk, through which lateral surface at least one planar sample defect is created.

“Running along the radius” encompasses here the case “running on the radius” and the case “running parallel to the radius” and also “running obliquely along the radius”.

Other embodiments provide a method for producing a sample disk, comprising the following steps: removing the first part from the first circular cylinder of the original sample disk and producing the at least one planar sample defect as a material transition from a closed planar end of a recess extending tangentially to the radius of the first circular cylinder by means of flat-bottom drilling taking place from the lateral surface and through the latter, to the sample disk.

Other embodiments provide a use of a sample disk by means positioning the sample disk in an ultrasonic disk testing installation, wherein test heads of a tandem or pitch-catch arrangement are in each case placed oppositely on the first base circle surface and the second base circle surface along the radius of the first base circle surface, and rotating the sample disk in a direction of rotation about the axis of symmetry in such a way that first of all planar sample defects and then the cut-out first part are guided past the test heads.

Embodiments of the invention allow artificial defects to be incorporated in an axial/radial orientation in a targeted manner and to use them to validate ultrasonic measuring methods.

According to one embodiment, the at least one planar sample defect can be created in a plane defined by means of the radius and the axis of symmetry. Such an orientation is particularly suitable for testing wheel disks.

According to a further embodiment, a first covering can cover the first part over its whole area in a planar and flush manner in the sample disk in the region of the first base circle surface.

According to a further embodiment, a second covering can cover the first part over its whole area in a planar and flush manner in the sample disk in the region of the second base circle surface.

It is thereby possible, after removing the first part, for the first base circle surface and the second base circle surface to be closed again or brought into the original state by means of the coverings.

According to a further embodiment, the at least one sample defect can be produced as a planar material transition.

According to a further embodiment, the planar material transition can be produced from ambient air to the sample disk.

According to a further embodiment, the planar material transition can be produced by means of a flat closed end of a recess which extends tangentially to the radius and which has an open end toward the lateral surface.

According to a further embodiment, the straight path section can run with a spacing parallel to the radius and the recess can extend perpendicularly to the lateral surface with a depth equal to the spacing.

According to a further embodiment, the recess and its flat closed end can have been produced by means of flat-bottom drilling from the side of the lateral surface.

According to a further embodiment, the at least one sample defect can have a round or an angular surface, in particular being circular, rectangular or triangular. For angular surfaces, an additional processing step in addition to, for example, the flat-bottom drilling is required. For example, use may be made of tools whose extents are smaller than the inside diameter of the recess.

According to a further embodiment, the guidance line can run along the straight path section to a circle line of the first base circle surface and along a relatively short circular arc of this circle line to a secant of the first base circle surface and along the secant in the direction of the axis of symmetry.

According to a further embodiment, the secant can run parallel to the first straight path section, wherein the relatively short circular arc is intended to have a preferably minimum length.

According to a further embodiment, the guidance line can run along the secant to a circle line of an inner circle, which is arranged in the first base circle surface and is concentric to the axis of symmetry, with a smaller radius than the radius of the first circular cylinder and along a relatively short circular arc of this circle line to the straight path section.

According to a further embodiment, a second part can be cut out in the sample disk, which part is a second right circular cylinder coaxial to the axis of symmetry, is bounded by the first base circle surface and the second base circle surface and has, in the first base circle surface, a smaller radius than the radius of the first circular cylinder. In this way, the sample disk can be designed as a wheel disk.

According to a further embodiment, the radius of the second circular cylinder can be equal to the radius of the inner circle.

According to a further embodiment, the straight path section can be produced with a spacing parallel to the radius of the first circular cylinder and perpendicularly to the lateral surface by means of flat-bottom drilling with a depth equal to the spacing.

According to a further embodiment, a second part can be removed from the first circular cylinder of the original sample disk before removing the first part.

According to a further embodiment, the first part of the sample disk can be covered over its whole area in a planar and flush manner in the region of the first base circle surface and/or in the region of the second base circle surface.

According to a further embodiment, a sample disk according to the invention can be used to evaluate or validate ultrasonic measuring methods or ultrasonic testing installations.

According to a further embodiment, a sample disk according to the invention can be used for mechanized and automated evaluation or validation.

According to a further embodiment, a sample disk according to the invention can be used for evaluating or validating test disks or test wheel disks measured by means of ultrasound, the sample disk having been adapted to a maximum to the physical extent of said disks.

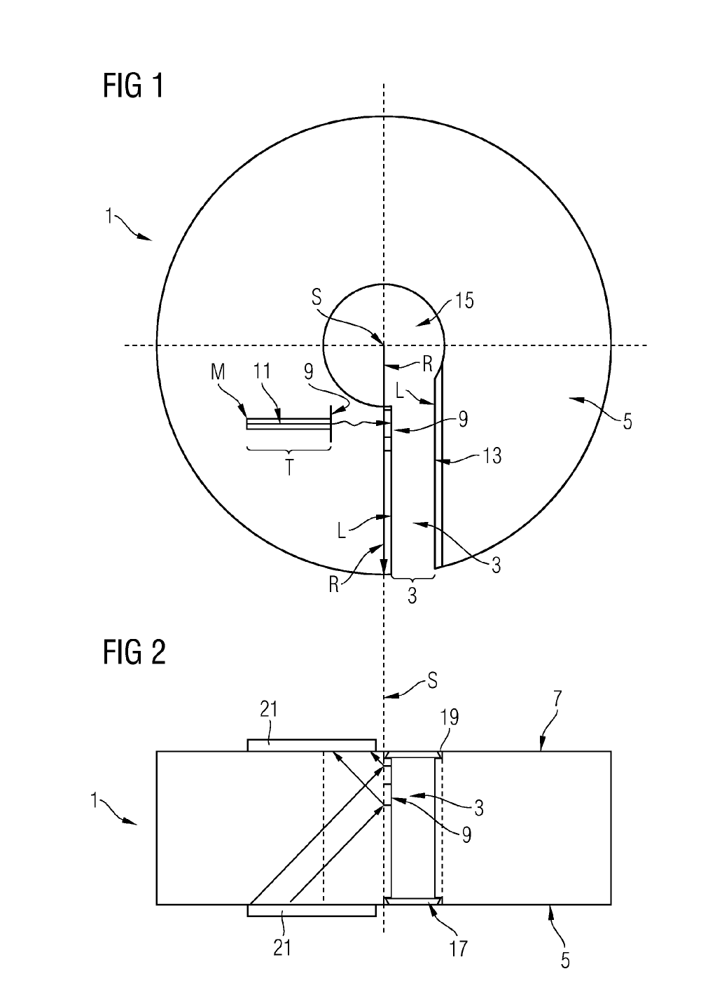

FIG. 1 shows a plan view of a first exemplary embodiment of a sample disk 1 according to the invention. This sample disk 1 is used in particular for ultrasonic disk testing installations.

The sample disk 1 is produced here as a wheel disk, for example. A geometric starting shape for a sample disk 1 according to the invention is a first right circular cylinder, which extends substantially about an axis of symmetry S, with a first base circle surface 5 having a radius R and with a second base circle surface 7 parallel to the first. Since FIG. 1 shows a plan view of the sample disk 1 from below, the first base circle surface 5 is illustrated and the second base circle surface is not visible. Here, the sample disk 1 is for example a wheel disk which has a bore or a concentric circular cutout about a center point. In addition, a first part 3 is cut out, which part is bounded by a surface produced by means of a parallel displacement of a straight line, which is parallel to the axis of symmetry S, along a closed guidance line L which runs in the first base circle surface 5, by the first base circle surface 5 and here by a surface identical to the second base circle surface 7. According to this exemplary embodiment, the first part 3 is separated out of an original sample disk 1 completely from the first base circle surface 5 to the second base circle surface 7. The guidance line L has, in particular, a straight path section which runs along the radius R. In connection with the further profile of the guidance line L, a lateral surface 9 is accessible from outside the sample disk 1 on the straight path section on the sample disk 1. According to this exemplary embodiment, as a result of a lateral surface 9 exposed in such a way, which surface is here a rectangle, four planar sample defects M have been created. These planar sample defects M are produced in a plane defined by means of the radius R and the axis of symmetry S. The sample defects M are created as a planar material transition. FIG. 1 shows a planar material transition from ambient air into the material of the sample disk 1. The planar material transitions are produced by means of a flat closed end of a recess 11 which extends tangentially to the radius R and which has an open end toward the lateral surface 9. In order that the sample defects M run on the radius, the straight path section is produced with a spacing parallel to the radius R, the recess 11 extending perpendicularly to the lateral surface 9 with a depth T equal to the spacing.

The recess 11 and its flat closed end can have been produced for example by means of flat-bottom drilling from the side of the lateral surface 9. A sample defect M can have a circular surface in a particularly simple manner. FIG. 1 shows that the guidance line L runs along the straight path section to a circle line of the first base circle surface 5 and then along a relatively short circular arc of this circle line to a secant 13 of the first base circle surface 5 and along this secant 13 in the direction of the axis of symmetry S. FIG. 1 shows that the secant 13 runs parallel to the first straight path section. The relatively short circular arc of the first base circle surface 5 is intended to have a minimum length. The sample disk 1 according to FIG. 1 has a second part 15 which is cut out. This second part 15 is a second right circular cylinder which is coaxial to the axis of symmetry S and which is bounded by the first base circle surface 5 and the second base circle surface 7 and has, in the first base circle surface 5, a smaller radius than the radius R of the first circular cylinder. The guidance line L runs along the secant 13 to the cut-out second part 15 and along a relatively short circular arc of the circle line of the second part 15 in the first base circle surface 5 back to the straight path section. Since the second part 15 is produced, the above-described profile from the secant to the straight path section is theoretical and is described here only for the definition of the first part 3. FIG. 1 here shows a closed profile of the guidance line L which is defined by the first part 3 and the second part 15. The first part 3 for exposing the lateral surface 9 and for incorporating the artificial defects, in particular in the form of flat-bottom holes, should be as narrow as possible. The size of the tool used has a major influence on this. The straight path section can in principle have any desired angle to the radius R. Care should merely be taken to ensure that the profile of the recess 11 runs tangentially to the radius R.

In a sample disk 1 according to the invention, which can also be referred to as a test body, inhomogeneities are incorporated in a targeted manner, with the result that, for example, turbine disks or shafts with corresponding defects can be simulated. The sample disk 1 should correspond by its geometric dimensioning to the test body. In order to realize the sample defects M, in particular flat-bottom holes with flat bottoms, in an axial and radial orientation, according to the invention a segment is separated out from an original disk or wheel disk. This corresponds to the first part 3. In addition, the first part 3 can be bounded by the second base circle surface 7. Alternatively, surfaces which run parallel to or arbitrarily along the second base circle surface 7 can bound the first part 3. Such boundary surfaces can in principle have any desired shapes, for example being curved or oblique to the first base circle surface 5. Resultant lateral surfaces 9 via which flat-bottom holes according to the invention can be incorporated should be exposed. The lateral surfaces 9 are generally not oriented radially to the disk center point or to the axis of symmetry S.

Accordingly, it is required, in dependence on a drilled length for a recess 11 that the latter be skewed slightly with respect to the lateral surface 9, with the result that in any event the flat bottom is produced so as to be oriented radially to the disk center point or to the axis of symmetry S.

FIG. 2 shows a side view of the first exemplary embodiment of a sample disk according to the invention as shown in FIG. 1. Correspondingly, the sample disk 1 has a lower first base circle surface 5 and an upper base circle surface 7. In the region of the first base circle surface 5 and in the region of the second base circle surface 7, the first part 3 is covered to the outside over its whole area in a planar and flush manner in each case by a first covering 17 and a second covering 19. It is particularly advantageous if the first base circle surface 5 and the second base circle surface 7 of the sample disk 1 are created as original and closed surfaces. The closed first base circle surfaces 5 and second base circle surfaces 7 make it possible for monitoring to be carried out in ultrasonic testing installations on conventional testing equipment or disk testing equipment in a mechanized and/or automated manner. FIG. 2 shows the first covering 17 and the second covering 19 as welded-in coverings for re-establishing a planar surface for uniform coupling of ultrasonic test heads. FIG. 2 shows an axis of symmetry S of the sample disk 1, which is visible only as a point in FIG. 1. FIG. 2 shows a tandem arrangement 21 in which a test head is arranged on the first base circle surface 5 and, oppositely, on the second base circle surface 7 along the radius R of the sample disk 1. Array test heads which are mounted in what is known as a pitch-catch arrangement are illustrated. FIG. 2 shows how ultrasound waves emanating from a lower array test head are reflected on the sample cases and deflected to the upper array test head. When testing a sample disk 1 according to the invention, the latter acts like a conventional component disk. The cut-out first part 3 can be detected by means of the testing arrangement using signals or calculated out or filtered out or taken into account of the signals to be assessed. The transition from the sample disk 1 to the cut-out first part 3 is unambiguously discernible in the signal and clearly distinguishable from the sample defects according to the invention.

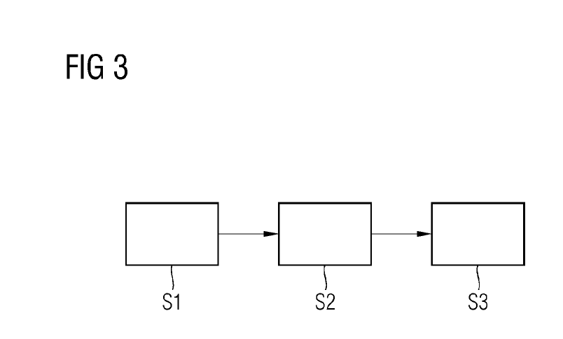

FIG. 3 shows an exemplary embodiment of a use according to the invention of a sample disk 1 according to the invention. In a first step S1, the sample disk 1 is positioned in an ultrasonic disk testing installation. For this purpose, test heads of a tandem arrangement are each placed oppositely one another on the first base circle surface and the second base circle surface along the radius of the first base circle surface. In a second step S2, the sample disk 1 is rotated in a direction of rotation about the axis of symmetry S in such a way that first of all the at least one planar sample defect M and then the cut-out first part 3 are guided past the test heads. In a third step S3, measuring methods and/or testing installations used, can be evaluated or validated, in particular in a mechanized or automated manner by means of the detected echo signals and the measurement signal. Accordingly, testing installations and measuring methods for detecting inhomogeneities in test objects, in particular in wheel and disk form, can be effectively improved and optimized.

What is claimed is:

1. A sample disk for ultrasonic disk testing installations, comprising
a sample disk body comprising a shape of a first right circular cylinder, extending about an axis of symmetry, and extending in a direction along the axis of symmetry from a first base circle surface having a radius to a second base circle surface parallel to the first base circle surface;
wherein the sample disk body comprises a cut-out that is bounded by a cut-out surface having a three-dimensional shaped defined by displacement of a straight line, which straight line extends parallel to the axis of symmetry, along a guidance line that runs in a plane parallel to the first base circle surface;
wherein the guidance line includes a straight path section that runs along the radius of the first base circle surface, such that a portion of the cut-out surface defined by the displacement of the straight line along the straight path section of the guidance line defines a lateral surface of the cut-out; and
at least one planar sample defect formed in the lateral surface of the cut-out.

2. The sample disk of claim 1, wherein the at least one planar sample defect is created in a plane extending through the radius of the first base circle surface and the axis of symmetry.

3. The sample disk of claim 1, comprising a first covering that fully covers the cut-out in a planar in a region of the first base circle surface.

4. The sample disk of claim 3, comprising a second covering that fully covers the cut-out in a region of the second base circle surface.

5. The sample disk of claim 1, wherein the at least one sample defect defines a planar material transition.

6. The sample disk of claim 5, wherein the planar material transition comprises a transition from ambient air to the sample disk.

7. The sample disk of claim 5, wherein the planar material transition comprises a recess that extends from the lateral surface of the cut-out to a flat closed end in a direction perpendicular to the radius of the first base circle surface.

8. The sample disk of claim 7, wherein the cut-out comprises a constant-width portion defined between the lateral surface of the cut-out and an opposing surface lying in a plane parallel to the lateral surface, wherein a width of the constant-width portion is equal to a depth of the recess.

9. The sample disk of claim 7, wherein the recess having the flat closed end is formed by flat-bottom drilling through the lateral surface of the cut-out.

10. The sample disk of claim 1, wherein the at least one sample defect has a circular, rectangular, or triangular shape.

11. The sample disk of claim 1, wherein the guidance line runs along an outer circular arc of the first base circle surface, along the straight path section, and along a smaller inner circular arc of of the first based circle surface, and along a secan of the first base circle surface, and along a secant of the first base circle surface extending between the inner circular arc and the outer circular arc of the first base circle surface.

12. The sample disk of claim 11, wherein the secant runs parallel to the straight path section of the guidance line.

13. The sample disk of claim 11, wherein the inner circular arc is concentric with the axis of symmetry and the outer circular arc.

14. The sample disk of claim 1, comprising further cut-out in the sample disk, the further cut-out having a shape of a right circular cylinder coaxial to the axis of symmetry, and extending from the first base circle surface to the second base circle surface, and having a smaller radius than a radius of the first circular cylinder.

15. (canceled)

16. A method for producing a sample disk, comprising:
providing a sample disk body comprising a shape of a first right circular cylinder extending about an axis of symmetry, and extending in a direction along the axis of symmetry from a first base circle surface having a radius to a second base circle surface parallel to the first base circle surface;
forming a curt-out in the sample disk body that is bounded by a cut-out surface having a three-dimensional shaped defined by a displacement of a straight line, which straight line extends parallel to the axis of symmetry, along a guidance line that runs in a plane parallel to the first base circle surface;
wherein the guidance line includes a straight path section that runs along the radius of the first base circle surface, such that a portion of the cut-out surface defined by the displacement of the straight line along the straight path section of the guidance line defines a lateral surface of the cut-out; and
producing at least one planar sample defect by flat-bottom drilling a recess through the lateral surface of the cut-out and into the sample disk body, wherein the recess is drilled in a direction perpendicular to the radius of the first base circle surface.

17. The method of claim 16, comprising producing the straight path section with a spacing parallel to the of the first circular cylinder and performing the flat-bottom drilling to a depth equal to the spacing.

18. The method of claim 16, comprising forming a second cut-out from the sample disk body before forming the first cut-out, the second cut-out located radially within the first cut-out.

19. The method of claim 16, comprising fully covering the first covering the first cut-out in at least one of a region of the first base circle surface and a region of the second base circle surface.

20. A method of using sample disk having a sample disk body including (a) a first right circular cylinder extending from a first base circle surface to a second base circle surface, and (b a cut-out that bounded by a cut-out surface having a three-dimensional shaped defined by a displacement of a straight line, which straight line extends parallel to the axis of symmetry, along a guidance line that runs in a plane parallel to the first base circle surface, which guidance line includes a straight path section that runs along the radius of the first base circle surface, such that a portion of the cut-out surface defined by the displacement of the straight line along the straight path section of the guidance line defines a lateral surface of the cut-out, and at least one planar sample defect formed in the lateral surface of the cut-out, the method comprising:
positioning the sample disk in an ultrasonic disk testing installation, wherein test heads of a tandem or pitch-catch arrangement are placed on opposite sides of the first base circle surface and the second base circle surface along the radius of the first base circle surface; and
rotating the sample disk in a direction of rotation about the axis of symmetry such that planar sample defects, followed by the cut-out, are guided past the test heads.

21. The use of claim 20, comprising evaluating or validating ultrasonic measuring methods or ultrasonic testing installations.

22. The use of claim 20, comprising performing mechanized and automated evaluation or validation.

23. The use of claim 20, comprising evaluating or validating test disks or test wheel disks using ultrasound, wherein the sample disk is adapted to a maximum to the physical extent of said disks.
